(19) United States
(12) Patent Application Publication
(10) Pub. No.: US 2005/0124075 A1
(43) Pub. Date: Jun. 9, 2005

(54) Method for the measurement of the pressure in a gas phase from rectification and/or absorption columns comprising (meth)acrylic acid the esters and/or nitriles thereof

(75) Inventors: Ulrich Hammon, Mannheim (DE); Jurgen Schroder, Ludwigshafen (DE); Steffen Rissel, Kirchheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/504,986

(22) PCT Filed: Mar. 12, 2003
(86) PCT No.: PCT/EP03/02501

(30) Foreign Application Priority Data
Mar. 14, 2002 (DE) 102 11 290.8

(51) Int. Cl. G01N 1/22

(52) U.S. Cl. 436/181; 436/149

(57) ABSTRACT

A process measures the pressure of a gas phase containing (meth)acrylic acid, the esters and/or nitrites thereof of a rectification and/or absorption column via open drillholes in the column wall and lines from the drillholes to the transducers by purging the lines with an oxygen-containing gas in the direction toward the open drillhole.

Measurement of the pressure in a gas phase containing (meth)acrylic acid, the esters and/or nitrites thereof of a rectification and/or absorption column

The present invention relates to a process for measuring the pressure in a gas phase containing (meth)acrylic acid, the esters and/or nitrites thereof of a rectification and/or absorption column where liquids containing (meth)acrylic acid, the esters and/or nitriles thereof are worked up rectificatively and/or gases containing (meth)acrylic acid, the esters and/or nitrites thereof are subjected to an absorption, said pressure to be measured being transferred to a transducer via an open drillhole in the column wall and a line which is connected to the open drillhole and is purged with a gas in the direction toward the open drillhole.

In this document, (meth)acrylic acid is an abbreviated notation for acrylic acid or methacrylic acid. The acids, the esters and/or nitrites thereof are valuable starting compounds for preparing polymers obtainable by free-radical polymerization which find use, for example, as adhesives.

(Meth)acrylic acid itself and the nitrites thereof are prepared industrially principally by heterogeneously catalyzed gas phase oxidation and/or ammoxidation of the appropriate alkenes or alkanes, or of the corresponding α,β-ethylenically unsaturated aldehydes.

However, this does not provide pure target compounds. Rather, a product gas mixture is obtained from which the target compound has to be removed. To this end, the desired (meth)acrylic compound is customarily absorbed in a solvent and subsequently removed via various rectification steps, optionally with the addition of azeotroping agents, from the absorbent and secondary components absorbed in addition to (meth)acrylic acid. Alternatively, the product gas mixture may also be fractionally condensed and the condensate obtained, which contains the desired (meth)acrylic compound, worked up rectificatively.

Esters of (meth)acrylic acid are prepared on the industrial scale generally by direct esterification of (meth)acrylic acid with alcohols, for example alkanols, in the presence of strong acids and optionally of an azeotroping agent to remove the water of esterification or by transesterification of (meth)acrylic esters with suitable alcohols, for example alkanols. The target ester is likewise customarily removed from the product mixture predominantly by rectification.

Useful rectification and/or absorption columns for the abovementioned removals of (meth)acrylic compounds are quite generally columns having varying internals. Examples of useful internals include trays (for example dual flow trays, sieve trays, valve trays, Thormann trays, tunnel cap trays and/or bubble cap trays), packings, Raschig rings and/or pall rings.

A disadvantage of the separating processes described is that the (meth)acrylic compounds are subjected to the same comparatively high temperature stresses which, even in the presence of polymerization inhibitors, can set off undesired polymerization. The formation of undesired polymer fouling, which in extreme cases is capable of blocking the column and reducing its throughput, is generally the consequence.

This is disadvantageous in that both absorptive removal and rectificative separation are based on a rising gas phase and falling liquid phase being in countercurrent to each other and not being in equilibrium. The resulting heat and mass transfer provides the desired separating performance. However, this only occurs when the liquid and gas (vapor) loadings are selected in such a way that on the one hand the rising gas phase does not entrain any significant quantity of liquid phase upward and on the other hand the liquid phase does not simply rain through downward.

When polymer fouling forming in a column reduces its throughput, the abovementioned balance is disturbed and the separating performance of the column is reduced.

An indicator for the formation of polymer fouling in a certain column section is the increase in difference between the gas pressure in the column below the polymer formation and the gas pressure in the column above the polymer formation. This means that the variation with time of the difference in the gas phase pressures of the column measured at various column heights are able to indicate the formation of polymer fouling. This may be removed by cleaning the column or compensated for by varying the evaporator output.

The measurement of pressures and the variation thereof in the gas phase of absorption and/or rectification columns (the two phenomena may also be superimposed) is accordingly of considerable significance.

One possible method of pressure measurement consists in transferring the gas phase pressure to be measured via an open drillhole in the column wall and a line connected to it (for example a pipe) to a transducer. The latter is the actual pressure measurer which transforms the gas pressure into another signal, for example an electrical signal.

Examples of gas pressure transducers include crystals (for example quartz) having piezoelectric properties. A pressure incident on the crystal surface results in electrical charges whose size depends on the magnitude of the incident force. This fact enables the utilization of the piezoelectric effect for pressure measurement. Alternatively, use may also be made of transistors, for example, whose current gain and output capacitance are pressure-dependent.

Further gas pressure tranducers are described in Ullmanns Encyklopädie der technischen Chemie, Verlag Chemie, Weinheim, 4th edition, volume 5, pages 822 to 832.

When working with aggressive gas phases and carrying out pressure measurement via an open drillhole and a pipe connected to it leading to a transducer, the abovementioned text recommends that the measuring line be continuously purged with nitrogen in the direction from the transducer to the open drillhole. The purging medium has to be metered in precisely and constantly with time at a higher pressure than the gas medium to be investigated (the additional pressure of the purging gas is taken into account in the calibration). Pressure variation of the purging stream leads to measurement errors. For metering in of the purging gas, rotameters may be installed, if necessary with an automatic regulating device (c.f. figure; 1=column, 2=measuring line, 3=transducer, 4=purge line, 5=rotameter, 6=regulation valve, 7=molecular nitrogen).

However, a disadvantage of such a nitrogen purge in the case of gas phases containing (meth)acrylic compounds is that in spite of the measuring lines being purged, the ends attached to the column block in the course of operation as a consequence of undesired polymer formation.

It is an object of the present invention to provide an improved process for pressure measurement.

EP-A 856 343 and EP-A 10 34 824 disclose the problem of undesired polymer formation of (meth)acrylic compounds in dead spaces. EP-A 10 84 740 suggests the solution of purging such dead spaces with a gas containing molecular oxygen as a countermeasure. There are no such dead spaces in the abovementioned pressure measurement employing nitrogen purge of the measuring line. Accordingly, no polymer formation occurs in the measuring line itself.

We have found that this object is achieved by a process for measuring the pressure in a gas phase containing (meth)acrylic acid, the esters and/or nitrites thereof of a rectification and/or absorption column where liquids containing (meth)acrylic acid, the esters and/or nitrites thereof are worked up rectificatively and/or gases containing (meth)acrylic acid, the esters and/or nitrites thereof are subjected to an absorption, said pressure to be measured being transferred to a transducer via an open drillhole in the column wall and a line (for example a pipe) which is connected to the open drillhole and is purged with a gas in the direction toward the open drillhole, which comprises purging the line with a molecular oxygen-containing gas.

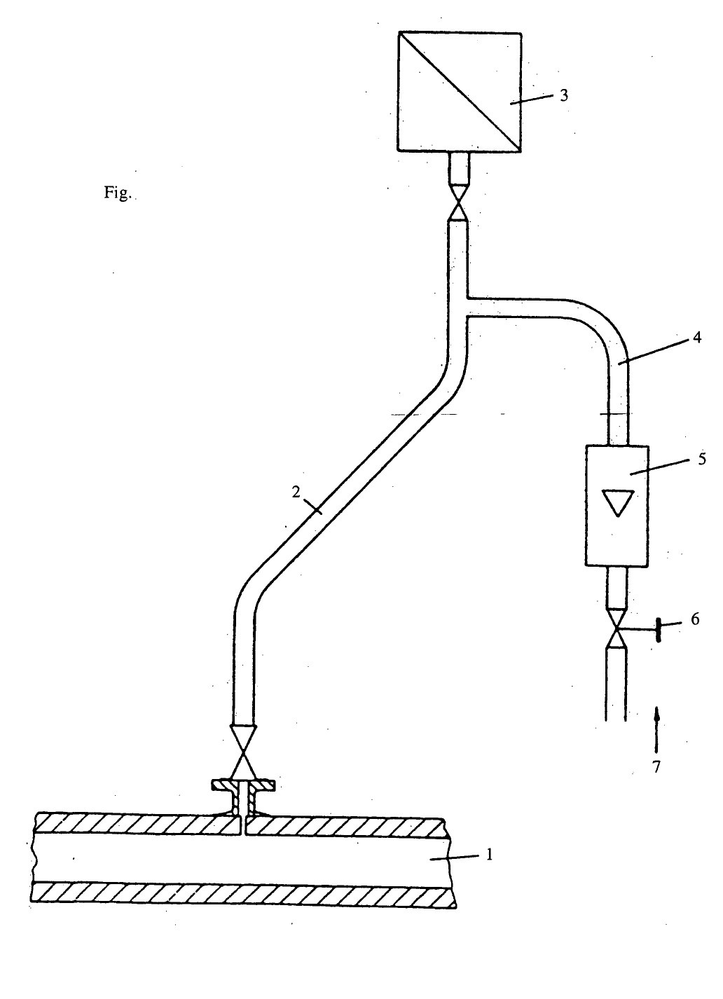

FIG. 1 shows a possible embodiment of the process according to the invention which contemplates the replacement of molecular nitrogen=7 by a molecular oxygen-containing purge gas.

According to the invention, preference is given to those molecular oxygen-containing purge gases whose molecular oxygen content is from 1 to 50% by volume, more preferably from 4 to 21% by volume. It will be appreciated that pure molecular oxygen may also be used.

Very particular preference is given to carrying out rectificative separation of liquids containing (meth)acrylic compounds and absorption of gases containing (meth)acrylic compounds having a flash point (determined to DIN EN 57) of ≦50° C. using a purge gas having a molecular oxygen content of from 4 to 10% by volume.

In this application, the term (meth)acrylic esters encompasses in particular the esters of (meth)acrylic acid with C₁- to C₁₂-alkanols, preferably with C₁- to C₈-alkanols and/or alkanediols. These include in particular methyl acrylate, methyl methacrylate, ethyl acrylate, ethyl methacrylate, n-butyl acrylate, tert-butyl acrylate, tert-butyl methacrylate and also 2-ethylhexyl acrylate, but also the esters of dimethylaminoethanol.

The liquids containing (meth)acrylic acid, the esters and/or nitrites thereof treated rectificatively in the process according to the invention may contain ≧20% by weight, or ≧40% by weight, or ≧60% by weight, or ≧80% by weight, or ≧90% by weight, or ≧95% by weight, or ≧99% by weight, of the (meth)acrylic compounds.

The rectification may be carried out at elevated pressure, atmospheric pressure or reduced pressure. It will be appreciated that the rectification and/or absorption columns in the process according to the invention are normally operated using polymerization inhibitors. In general, the polymerization inhibitors are added to the reflux. Useful polymerization inhibitors include all inhibitors which are usable in the manner known per se. Examples include phenothiazine, hydroquinone and hydroquinone monomethyl ether. As an additional stabilizing measure, a molecular oxygen-containing gas, for example air, may additionally be passed through the column.

### EXAMPLES

### Inventive Example 1

A tray column (material: stainless steel having the materials number 1.4571 corresponding to the DIN standard EN 10020) of 3.8 m diameter and 32 m length was provided with pressure measuring nozzles having a nominal width (internal diameter of the drillhole) of 25 mm and a length of 400 mm which were welded on flush to the column wall.

Fourteen of these measuring nozzles were arranged vertically along the column wall in such a manner that the drillhole of one nozzle was between two trays of the separating column. The separation between two consecutive dual flow trays (material: stainless steel having the materials number 1.4571 according to DIN standard EN 10020), of which there were 45 in total, was 400 mm over the entire column. The upper edge of each drillhole was 10 cm below the tray.

The measuring nozzles were connected in pairs by a pipe of 12 mm nominal width to a differential pressure transducer.

The tray column was used to rectificatively separate acrylic acid from the liquid of the composition described below (feed quantity=114 metric tons/h via the feedline of the column).

The liquid contained:

| | | |
|---|---|---|
| 17% | by weight | of acrylic acid, |
| 0.02% | by weight | of water, |
| 0.0015% | by weight | of acrolein, |
| 0.0015% | by weight | of allyl acrylate, |
| 0.01% | by weight | of furfural, |
| 0.027% | by weight | of acetic acid, |
| 0.2% | by weight | of benzaldehyde, |
| 0.003% | by weight | of propionic acid, |
| 0.032% | by weight | of maleic anhydride, |
| 58% | by weight | of diphyl, |
| 17.0% | by weight | of dimethyl phthalate, |
| 3% | by weight | of acryloylpropionic acid and |
| 0.02% | by weight | of phenothiazine. |

37 trays were disposed above the feed point and 8 trays were disposed below the feed point for the acrylic acid-containing liquid.

The dual flow trays above the feed had drillholes of diameter 25 mm and the dual flow trays below the feed had drillholes of diameter 50 mm (each measured internally). The acrylic acid-containing liquid was separated into 99.6% by weight acrylic acid, a mixture of the components having boiling points lower than acrylic acid which contained less than 96% by weight of acrylic acid, and a mixture of components having boiling points higher than acrylic acid which contained less than 0.5% by weight of acrylic acid. The temperature at the top of the column was 80° C., the pressure at the top of the column 105 mbar and the reflux ratio 1.3. The temperature at the bottom of the column was 193° C. and the pressure at the bottom of the column 230 mbar. The reflux of the column was stabilized with such a phenothiazine quantity that the 99.6% by weight acrylic acid withdrawn via the sidestream takeoff (at tray 35, counted from below) contains 250 ppm by weight of PTZ. The PTZ was added dissolved in acrylic acid removed in this manner (as a 1.5% by weight solution). In addition, 400 000 l/h (STP) of air were additionally passed into the lower region of the rectification column.

In total (including the purge air in the pipes), 84 294 l/h (STP) of molecular oxygen were added to the rectification column.

Within an operating time of 35 days, the drillhole of only one of the 14 measuring nozzles had to be cleaned to remove polymer.

### Inventive Example 2

Inventive example 1 was repeated, except that instead of air, a mixture of 7% by volume of oxygen and 93% by volume of nitrogen was used in the same quantity as purge gas. Also, 410 000 l/h (STP) of air were passed into the lower region of the rectification column. In total, 86 200 l/h (STP) of molecular oxygen were added to the rectification column.

Within an operating time of 35 days, the drillholes of 5 measuring nozzles had to be cleaned to remove polymer.

### Comparative Example 1

Inventive example 1 was repeated, except that purging was effected using molecular nitrogen instead of air. In addition, 420 000 l/h (STP) of air were passed into the lower region of the rectification column for stabilization.

In total, 88 200 l/h (STP) of molecular oxygen were added to the rectification column.

Within an operating time of 35 days, the drillholes of all 14 measuring nozzles had to be cleaned more than once to remove polymer.

### Inventive Example 3

A rectification column (material: stainless steel having the material number 1.4541 according to DIN standard EN 10020) was used to separate a product mixture which contained the following components:
2.5% by weight of methanol,
0.004% by weight of methacrylic acid,
96.3% by weight of methyl methacrylate,
0.5% by weight of methyl acetate,
0.06% by weight of methyl propionate,
1.4% by weight of water and
0.01% by weight of hydroquinone.

The rectification column was used to separate the product mixture into a low boiler mixture containing less than 23% by weight of methyl methacrylate and a high boiler mixture containing more than 99% by weight of methyl methacrylate. The separating internals contained in the column were 60 dual flow trays (having drilled holes of diameter 15 mm, material: stainless steel having the materials number 1.4541 according to DIN standard EN 10020). The feed was at tray 50 (counted from below).

The temperature at the top of the column was 101° C., the pressure 930 mbar and the reflux ratio 2.2. The temperature at the bottom of the column was 105° C. and the pressure 1110 mbar.

The rectification column contained 8 open drillholes in the column wall to which pipes each leading to a pressure transducer were attached. Each feed to the pressure transducers was purged with 100 l/h (STP) of a mixture consisting of 92% by volume of nitrogen and 8% by volume of oxygen. In addition, 400 l/h (STP) of air were passed into the lower region of the rectification column for stabilization. The reflux of the rectification column also contained 100 ppm by weight of hydroquinone.

The total feed of molecular oxygen was therefore 148 l/h (STP).

After a running time of 180 days, all pressure measuring devices were still functioning.

### Comparative Example 2

Inventive example 3 was repeated, except that the feeds to the pressure transducers were purged with 100 l/h (STP) of nitrogen. Also, 800 l/h (STP) of air were passed into the lower region of the rectification column.

The total feed of molecular oxygen was therefore 168 l/h (STP).

After a running time of 30 days, 6 of the 8 open drillholes in the column wall were blocked by polymer.

1. A process for measuring the pressure in a gas phase containing (meth)acrylic acid, the esters and/or nitriles thereof of a rectification and/or absorption column where liquids containing (meth)acrylic acid, the esters and/or nitrites thereof are worked up rectificatively and/or gases containing (meth)acrylic acid, the esters and/or nitriles thereof are subjected to an absorption, said pressure to be measured being transferred to a transducer via an open drillhole in the column wall and a line which is connected to the open drillhole and is purged with a gas in the direction toward the open drillhole, which comprises purging the line with a molecular oxygen-containing gas.

2. A process as claimed in claim 1, wherein the line is purged with air.
